(19) United States
(12) Patent Application Publication
(10) Pub. No.: US 2017/0243578 A1
(43) Pub. Date: Aug. 24, 2017

(54) VOICE PROCESSING METHOD AND DEVICE

(71) Applicant: Samsung Electronics Co., Ltd., Gyeonggi-do (KR)

(72) Inventors: Dong Il SON, Gyeonggi-do (KR); Youn Hyoung KIM, Gyeonggi-do (KR); Geon Ho YOON, Seoul (KR); Chi Hyun CHO, Gyeonggi-do (KR); Chang Ryong HEO, Gyeonggi-do (KR)

(73) Assignee: Samsung Electronics Co., Ltd.

(21) Appl. No.: 15/436,297

(22) Filed: Feb. 17, 2017

(30) Foreign Application Priority Data
Feb. 18, 2016 (KR) 10-2016-0019391

(51) Int. Cl. G10L 15/22; G10L 25/84; G10L 21/0232

(52) U.S. Cl. CPC G10L 15/22; G10L 21/0232; G10L 25/84; G10L 2015/223; G10L 2021/02166

(57) ABSTRACT

An electronic device and a voice processing method of the electronic device are provided. The electronic device includes a microphone array including a plurality of microphones facing specified directions; a sensor module configured to sense a user located near the electronic device; and a processor configured to select one of a plurality of users sensed near the electronic device, process a voice received from a direction in which the selected user is located, as a user input, and process a voice received from another direction, as noise.

### PRIORITY

This application claims priority under 35 U.S.C. §119(a) to Korean Patent Application Serial No. 10-2016-0019391, which was filed in the Korean Intellectual Property Office on Feb. 18, 2016, the entire disclosure of which is incorporated herein by reference.

### BACKGROUND

1. Field of the Disclosure

The present disclosure relates to a method and a device that process a voice received from a user.

2. Description of the Related Art

Various types of electronic products are being developed and distributed, which provide various services such as an e-mail service, a web surfing service, a photographing service, an instant message service, a scheduling service, a video playing service, an audio playing service, etc., by recognizing a user voice and using the recognized user voice to execute a corresponding service.

However, when an electronic device receives a user voice via a microphone, a variety of noises occurring around the electronic device may also be received. In addition, a voice output from a device such as a television (TV), a radio, etc., as well as a user conversation may inadvertently be recognized by the electronic device as a user voice command, which may cause the electronic device to perform an unintended function.

### SUMMARY

The present disclosure is made to address at least the above-mentioned problems and/or disadvantages and to provide at least the advantages described below.

Accordingly, an aspect of the present disclosure is to provide an improved voice processing device and method and by obtaining a user voice with low-noise, by removing various noises occurring around an electronic device, and by processing only an voice command, which is input while the user is present.

In accordance with an aspect of the present disclosure, an electronic device is provided, which includes a microphone array including a plurality of microphones facing specified directions; a sensor module configured to sense a user located near the electronic device; and a processor configured to select one of a plurality of users sensed near the electronic device, process a voice received from a direction in which the selected user is located, as a user input, and process a voice received from another direction, as noise.

In accordance with another aspect of the present disclosure, a voice processing method is provided for an electronic device, which includes sensing a plurality of users located near the electronic device; receiving voices via a microphone array including a plurality of microphones facing specified directions; selecting one of the plurality of users; processing a voice received from a direction in which the selected user is located, as a user input; and processing a voice received from another direction, as noise.

In accordance with another aspect of the present disclosure, a non-transitory computer-readable recording medium is provided for recording a program, which when executed, causes a computer to sense a plurality of users located near the electronic device; receive voices via a microphone array including a plurality of microphones facing specified directions; select one of the plurality of users; processing a voice received from a direction in which the selected user is located, as a user input; and processing a voice received from another direction, as noise.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device, according to an embodiment of the present disclosure;

FIG. 2 illustrates an arrangement of microphones, according to an embodiment of the present disclosure;

FIG. 3 illustrates an arrangement of microphones, according to an embodiment of the present disclosure;

FIG. 4 illustrates an arrangement of microphones, according to an embodiment of the present disclosure;

FIG. 5 illustrates a user interface, according to an embodiment of the present disclosure;

FIG. 6 illustrates a voice processing method of an electronic device, according to an embodiment of the present disclosure;

FIG. 7 illustrates a voice processing method of an electronic device, according to an embodiment of the present disclosure;

FIG. 8 illustrates examples an electronic device, according to an embodiment of the present disclosure;

FIG. 9 illustrates an electronic device, according to an embodiment of the present disclosure;

FIG. 10 illustrates an electronic device in a network environment, according to an embodiment of the present disclosure;

FIG. 11 illustrates an electronic device, according to an embodiment of the present disclosure;

FIG. 12 illustrates an electronic device, according to an embodiment of the present disclosure; and

FIG. 13 illustrates a software block diagram of an electronic device, according to an embodiment of the present disclosure.

### DETAILED DESCRIPTION

Hereinafter, various embodiments of the present disclosure are described with reference to the accompanying drawings. However, the present disclosure is not intended to be limited by the various described embodiments and is intended to cover all modifications, equivalents, and/or alternatives that come within the scope of the appended claims and their equivalents.

With respect to the descriptions of the accompanying drawings, like reference numerals refer to like elements, features, and structures.

Terms used in the present disclosure are used to describe specified embodiments and are not intended to limit the scope of the present disclosure. The terms of a singular form may include plural forms unless otherwise specified.

All the terms used herein, which include technical or scientific terms, may have the same meanings as are generally understood by a person skilled in the art. Terms that are defined in a dictionary and commonly used should also be interpreted as is customary in the relevant related art and not in an idealized or overly formal ways unless expressly defined as such herein. In some cases, even if terms are defined in the specification, they may not be interpreted to exclude embodiments of the present disclosure.

The terms “include,” “comprise,” “have”, “may include,” “may comprise” and “may have” indicate recited functions, operations, or existence of elements but do not exclude other functions, operations, or elements.

The expressions “including A or B”, “including at least one of A or/and B”, or “including one or more of A or/and B” may refer to (1) where at least one A is included, (2) where at least one B is included, or (3) where both of at least one A and at least one B are included.

The terms, such as “first”, “second”, etc., used herein may differentiate various elements in the present disclosure, but do not limit the elements. For example, “a first user device” and “a second user device” may indicate different user devices regardless of the order or priority thereof. Accordingly, a first element may be referred to as a second element, and similarly, a second element may be referred to as a first element.

When an element (e.g., a first element) is referred to as being “(operatively or communicatively) coupled with/to” or “connected to” another element (e.g., a second element), the first element may be directly coupled with/to or connected to the second element or an intervening element (e.g., a third element) may be present therebetween. However, when the first element is referred to as being “directly coupled with/to” or “directly connected to” the second element, no intervening element may be present therebetween.

According to context, the expression “configured to” may be used interchangeably with “suitable for”, “having the capacity to”, “designed to”, “adapted to”, “made to”, or “capable of”. The expression “configured to” does not necessarily mean “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor (AP)) which performs corresponding operations by executing one or more software programs stored in a memory device.

Herein, the term “user” may refer to a person who uses an electronic device or may refer to a device (e.g., an artificial intelligence (AI) electronic device) that uses an electronic device.

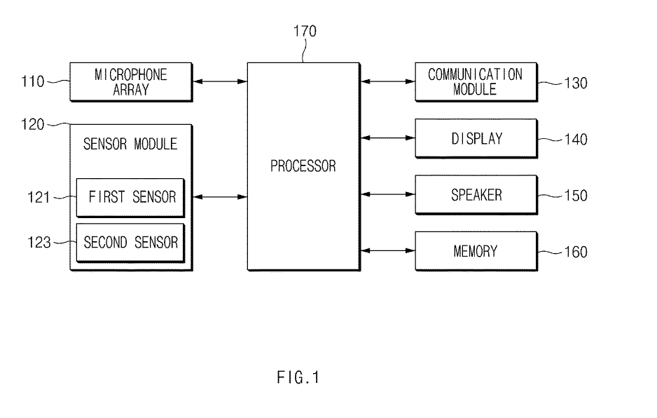

FIG. 1 illustrates an electronic device, according to an embodiment of the present disclosure.

Referring to FIG. 1, an electronic device includes a microphone array 110, a sensor module 120, a communication module 130, a display 140, a speaker 150, a memory 160, and a processor 170.

The microphone array 110 may include a plurality of microphones that are arranged to face specified directions. For example, the plurality of microphones included in the microphone array 110 may face different directions from each other. The plurality of microphones included in the microphone array 110 may receive sound (e.g., a voice) and to may change the received sound into an electrical signal (or a voice signal). The microphone array 110 may send the voice signal to the processor 170.

The sensor module 120 may sense a user located around an electronic device. For example, the sensor module 120 may include a passive infrared (PIR) sensor, a proximity sensor, an ultra-wide band (UWB) sensor, an ultrasonic sensor, an image sensor, a heat sensor, etc. Alternatively, the electronic device 100 may include a plurality of the sensor modules. Each of the plurality of sensor modules may sense whether a user is present in a specified area, a distance between the user and the electronic device 100, and a direction of the user. For example, each of the plurality of sensor modules may sense whether a user is present in a location corresponding to a direction that one of the plurality of microphones included in the microphone array 110 faces.

The sensor module 120 includes a first sensor 121 and a second sensor 123. The first sensor 121 may sense a body of the user, e.g., whether the body of the user is present within a range in the specified direction. The first sensor 121 may include a PIR sensor, a UWB sensor, and a heat (e.g., body temperature) sensor. The PIR sensor may sense whether the user is present, by using a variation in infrared rays received from the user's body.

The second sensor 123 may sense a specific direction or distance of an object (or a body) that is located within a range in the specified direction. The second sensor 123 may include an ultrasonic sensor, a proximity sensor, and a radar. The ultrasonic sensor may transmit ultrasonic waves to a specified direction and may sense the specific direction or distance of the object based on the ultrasonic waves that are reflected on the object and received.

The communication module 130 may communicate with an external electronic device (e.g., a voice recognition server). The communication module 130 may include a radio frequency (RF) module, a cellular module, a wireless-fidelity (Wi-Fi) module, a global navigation satellite system (GNSS) module, a Bluetooth module, and/or a near field communication (NFC) module. The electronic device may be connected to a network (e.g., an Internet network or a mobile communication network) through at least one of the modules, and thus, the electronic device may communicate with the external electronic device.

The display 140 may display a user interface (or content). The display 140 may display feedback information corresponding to a user voice. The display 140 may change the user interface or the content based on the user voice and may display the changed user interface or content.

The speaker 150 may output audio, e.g., voice feedback corresponding to a user voice command.

The memory 160 may store data for recognizing the user voice, data for providing the feedback associated with the user voice, and/or user information. For example, the memory 160 may store information for distinguishing user voices.

The processor 170 may control overall operations of the electronic device. The processor 170 may control each of the microphone array 110, the sensor module 120, the communication module 130, the display 140, the speaker 150, and the memory 160 to recognize and process a user's voice. The processor 170 (e.g., an AP) may be implemented with a system on chip (SoC) including a central processing unit (CPU), a graphic processing unit (GPU), a memory, etc.

The processor 170 may determine whether the user is located near the electronic device 100 and a direction on which the user is located, by using information received from the sensor module 120. The processor 170 may determine whether the user is present, by using at least one of the first sensor 121 and the second sensor 123.

The processor 170 may activate the first sensor 121, while keeping the second sensor 123 inactive, when the user is not sensed near the electronic device. When the first sensor 121 is activated, if the user's body is sensed by the first sensor 121, the processor 170 may activate the second sensor 123. If the user's body is sensed by the first sensor 121, the processor 170 may deactivate the first sensor 121, immediately or after a specified time elapses.

When the second sensor 123 is activated, if the user is not sensed by the second to sensor 123, the processor 170 may re-activate the first sensor 121. When the second sensor 123 is activated, if the user is not sensed by the second sensor 123, the processor 170 may deactivate the second sensor 123, immediately or after a specified time elapses.

The processor 170 may process a voice signal received from the microphone array 110.

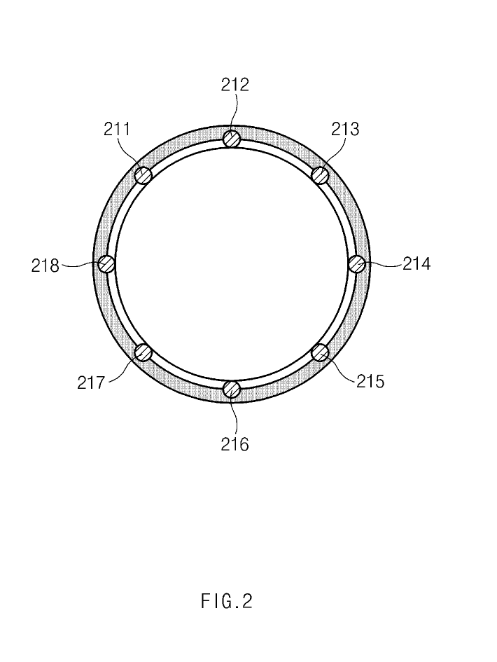

FIG. 2 illustrates an arrangement of microphones, according to an embodiment of the present disclosure.

Referring to FIG. 2, an electronic device may include a microphone array including a plurality of microphones 211 to 218. The plurality of microphones 211 to 218 may be arranged in different directions, respectively.

A processor of the electronic device may process a voice, which is received from a specified direction, from among voices received through the plurality of microphones 211 to 218 as a user input. Further, the processor may process other voices, which are received from other directions, as noise. For example, the processor may select some of the plurality of microphones 211 to 218, may process a voice signal (or a first voice signal), which is received from the selected microphones, as the user input, and may process a voice signal (or a second voice signal), which is received from the unselected microphones, as noise.

The processor may perform noise canceling on the first voice signal by using the second voice signal. For example, the processor may generate an antiphase signal of the second voice signal by inverting the second voice signal and may synthesize the first voice signal and the antiphase signal.

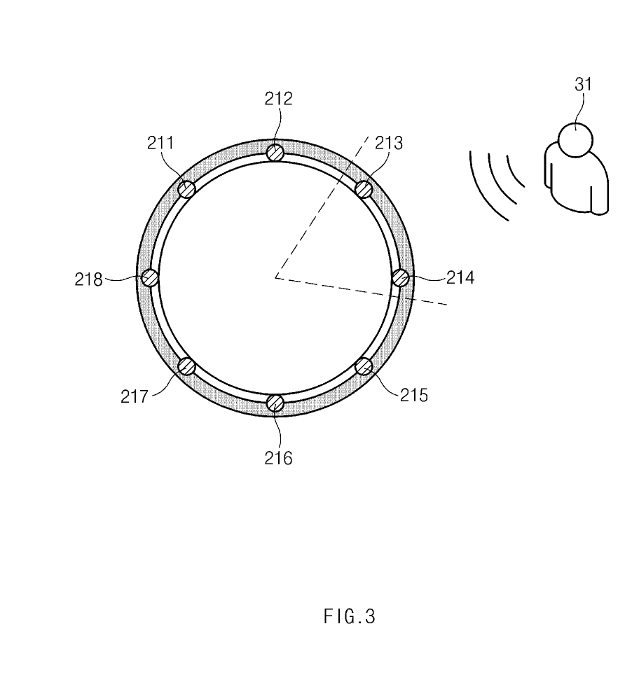

FIG. 3 illustrates an arrangement of microphones, according to an embodiment of the present disclosure. Specifically, FIG. 3 illustrates the arrangement of microphones of FIG. 2, but with a user 31 located between microphones 213 and 214.

Referring to FIG. 3, the processor may process a voice, which is received from a direction in which the user 31 is located, from among voices received through the plurality of microphones 211 to 218 as a user input. Further, the processor may process voices received from other directions as noise. For example, the processor may select microphone 213 and microphone 214, which face the direction in which the user 31 is located, from among the plurality of microphones 211 to 218. The processor may process voice signals received from the microphones 213 and 214 as user inputs and may process voice signals received from the unselected microphones 211, 212, 215, 216, 217, and 218 as noise.

The processor may perform noise canceling on voice signals received from the microphones 213 and 214 by using the voice signals received from the unselected microphones 211, 212, 215, 216, 217, and 218. For example, the processor may generate antiphase signals by inverting the voice signals received from the unselected microphones 211, 212, 215, 216, 217, and 218 and may synthesize voice signals, which are received from the third microphones 213 and 214, and the antiphase signals.

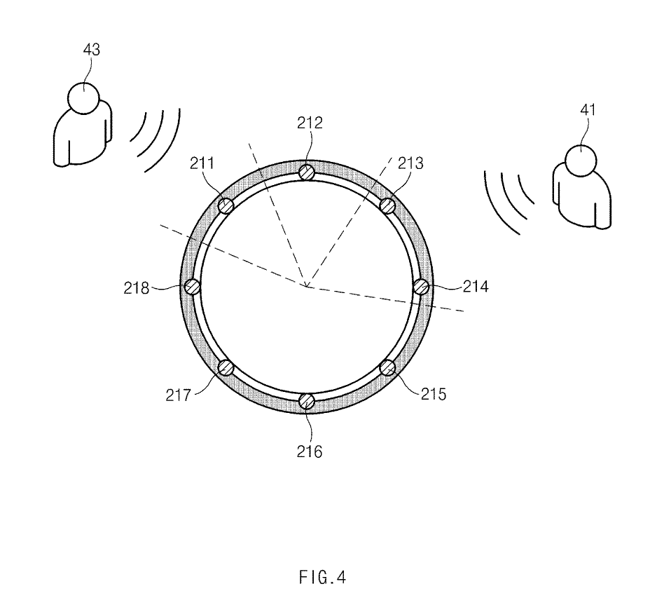

FIG. 4 illustrates an arrangement of microphones, according to an embodiment of the present disclosure. Specifically, FIG. 4 illustrates the arrangement of microphones of FIG. 2, but with a plurality of users 41 and 43 located around the microphones 211 to 218.

Referring to FIG. 4, a first user 41 and a second user 43 are present around the electronic device. Accordingly, the processor may process voices, which are received from directions in which the users 41 and 43 are located, as user inputs, and may process voices, which are received from other directions, as noise. For example, the processor may select the microphones 211, 213, and 214, which face the directions in which the users 41 and 43 are located, from among the plurality of microphones 211 to 218. The processor may process voice signals received from the selected microphones 211, 213, and 214, as user inputs, and may process voice signals received from the unselected microphones 212, 215, 216, 217, and 218, as noises.

Alternatively, the processor may select one of the users 41 and 43 to receive voice command from. The processor may process a voice, which is received from a specified direction in which the selected user is located, from among voices received through the plurality of microphones 211 to 218, as the user input. The processor may process voices received from other directions as noise. For example, if the first user 41 is selected, the processor may process voice signals, which are received from the microphones 213 and 214 that face the direction in which the first user 41 is located, as user inputs, and may process voice signals received from the other microphones 211, 212, 215, 216, 217, and 218 as noise. However, if the second user 43 is selected, the processor may process a voice signal received from the microphone 211 that faces the direction in which the second user 43 is located, as the user input, and may process voice signals received from the other microphones 212 to 218 as noise.

The processor may distinguish the plurality of users by using a voice signal received through at least one of the microphones 211 to 218. For example, the processor may distinguish the first user 41 and the second user 43 by analyzing characteristics of the voice signal received through at least one of the microphones 211 to 218. The processor may distinguish the plurality of users by comparing the voice signal, which is received through at least one of the microphones 211 to 218, with a voice signal stored in a memory.

The processor may determine a direction, from which a voice is uttered, (or a direction in which the user is located) by using a voice signal received through at least one of the microphones 211 to 218. For example, if a voice that the first user 41 utters is received through at least some of a plurality of microphones 211 to 218, the processor may determine whether a voice of the first user 41 has been uttered from a direction, which the microphones 213 and 214 face, based on a level (or a magnitude) of a voice received through the at least one of the microphones 211 to 218.

As another example, if a voice that the second user 43 utters is received through at least some of a plurality of microphones 211 to 218, the processor may determine that the voice of the second user 43 has been uttered from a direction, which the microphone 111 faces, based on the level (or the magnitude) of the voice received through at least one of the microphones 211 to 218.

If a plurality of users are present around the electronic device, the processor may determine priorities of the plurality of users, respectively.

The processor may determine a degree of friendship between each of the plurality of users based on conversation records (e.g., the number of occurrences of a conversation, talk time, conversation contents, etc.) of each of the plurality of users. The processor may determine priorities of the plurality of users based on the degrees of friendship of the plurality of users, respectively.

If a specified command is received, the processor may determine which of the plurality of users has uttered the specified command. If the plurality of users (e.g., the first user 41 and the second user 43) are present around the electronic device, the processor may select the user, which utters the specified command first, from among the plurality of users. For example, when the first user 41 utters a specified command first, the processor may process voice signals, which are received from the microphones 213 and 214 that face the direction in which the first user 41 is located, as the user inputs, and may process voice signals received from the other microphones 211, 212, 215, 216, 217, and 218, as noise.

If the first user 41 and the second user 43 are present around the electronic device, the processor may select the user having the highest a priority, from among the plurality of users. If the utterance of the user of which the priority is the highest ends, the processor may then select a user that has the next highest priority. For example, if a voice has not been uttered from the selected user during a specified time period, the processor may determine that the utterance of the selected user ends and may select another user.

The processor may perform voice recognition by using a voice signal on which noise canceling is performed. The processor may change the voice signal into a text. For example, the processor may change the voice signal into the text by using a speech to text (STT) algorithm. The processor may recognize a user intention by analyzing the text. For example, the processor may perform natural language understanding (NLU) and dialog management (DM) on the text. The processor may search for or generate information (hereinafter referred to as “feedback information”) corresponding to a user's intention included in the recognized voice. The feedback information may include various types of content, e.g., text, audio, an image, etc.

At least some of the above-mentioned voice recognizing processes and the above-mentioned feedback providing processes may be performed by an external electronic device (e.g., a server). For example, the processor may send the voice signal, on which the noise canceling is performed, to an external server and may receive text corresponding to the voice signal from the external server. As another example, the processor may send the text to the external server and may receive the feedback information corresponding to the text from the external server.

The processor may indicate which of a plurality of users located around the electronic device is selected (or which user voice is being recognized). For example, the electronic device may include a plurality of light emitting diodes (LEDs) arranged to correspond to directions that the plurality of microphones 211 to 218 face, and the processor may turn on an LED corresponding to the direction on which the selected user is currently located.

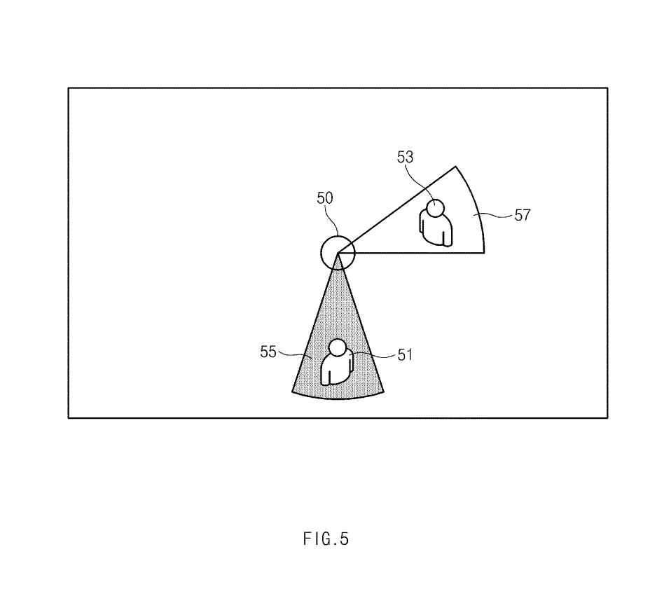

FIG. 5 illustrates a user interface, according to an embodiment of the present disclosure. Specifically, a processor of an electronic device may display the user interface indicating which of a plurality of users located around the electronic device is selected.

Referring to FIG. 5, the user interface includes a first object 50 indicating the electronic device, a second object 51 indicating a first user, and a third object 53 indicating a second user. If the first user and the second user are sensed by a sensor module, the processor may display the second object 51 and the third object 53, which correspond to the sensed users, in the user interface. If the user moves, the processor may change and display locations of the first object 50 and the third object 53, such that the locations correspond to movement of the user.

Referring to FIG. 5, the user interface includes a fourth object 55 indicating an area in which the electronic device will recognize the first user's voice, and a fifth object 57 indicating an area in which the electronic device will recognize the second user's voice.

An area in which the electronic device will recognize a voice may be determined by a location of the user. If the location of the user is changed, the area in which the electronic device will recognize the voice may also be changed.

The processor may display the user interface in order to indicate the selected user (or a user of a voice for which voice recognition is performed) of a plurality of users located around the electronic device. For example, if the first user is being selected, the processor may display a color and transparency of the fourth object 55 to be different from those of the fifth object 57 or may allow the fourth object 55 to flicker. As another example, the processor may display a separate object indicating a currently selected user.

The processor may provide feedback associated with the recognized voice. The processor may display feedback information in a display. The processor may output the feedback information through a speaker. If the feedback information in text form is received, the processor may change the text to voice by using a text to speech (US) algorithm and may output the feedback information in voice form through the speaker.

The processor may execute a function corresponding to the recognized voice. The processor may execute a function corresponding to a user's intention conveyed through the voice command. For example, the processor 170 may execute specified software based on the user intention or may change the user interface.

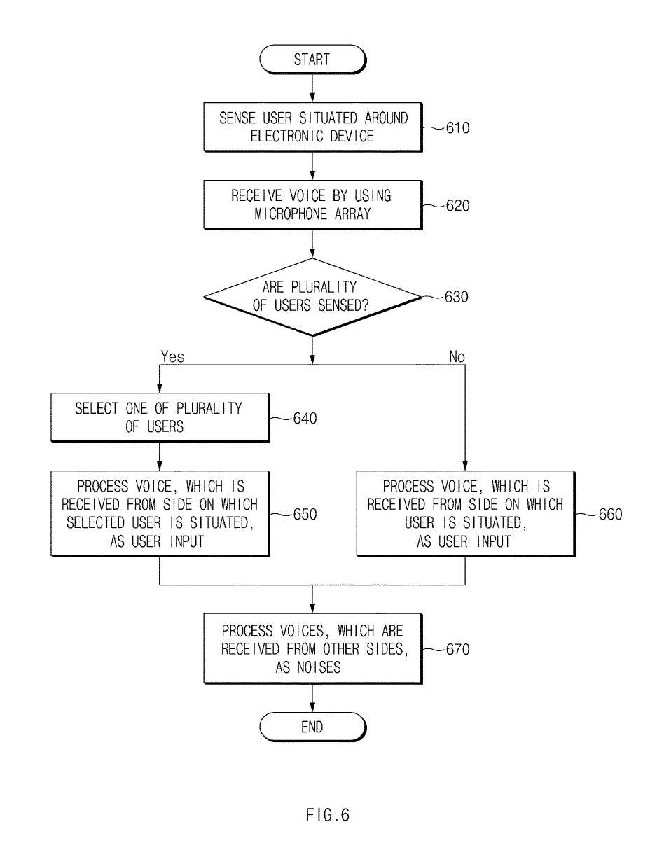

FIG. 6 illustrates a voice processing method of an electronic device, according to an embodiment of the present disclosure. For example, the method of FIG. 6 may be performed by the electronic device illustrated in FIG. 1.

Referring to FIG. 6, in step 610, the electronic device senses a user located near the electronic device, e.g., by using a sensor module. The electronic device may determine whether the user is located near the electronic device and a direction in which the user is located, by using the sensor module.

In step 620, the electronic device receives a voice via a microphone array. The microphone array may include a plurality of microphones that are arranged to face specified directions. The plurality of microphones included in the microphone array may face different directions from each other.

In step 630, the electronic device determines whether a plurality of users are sensed.

If a plurality of users is sensed in step 630, the electronic device selects one of the plurality of users in step 640. For example, the electronic device may select one the plurality of users as described above with reference to FIG. 4.

In step 650, the electronic device processes a voice received from a direction in which the selected user is located, from among voices received through the plurality of microphones, as a user input.

However, if a plurality of users are not sensed (or if only one user is sensed) in step 630, the electronic device processes a voice received from a direction in which a user is located, as the user input, in step 660.

In step 670, the electronic device process voices received from other directions as noise. For example, the electronic device may perform noise canceling on a voice received from a direction in which the selected user is located, by using voices received from other directions.

The electronic device may perform voice recognition on a voice signal on which the noise canceling is performed. The electronic device may change the voice signal into text, and then recognize a user intention by analyzing the text. The electronic device 100 may search for or generate feedback information corresponding to the recognized user intention. As described above, the feedback information may include text, audio, an image, etc.

The electronic device may provide feedback associated with the recognized voice. The electronic device may display the feedback information in a display and/or output the feedback information through a speaker. If the feedback information in text form is received, the electronic device may change the text to voice by using a TTS algorithm and may output the feedback information in voice form through the speaker.

The electronic device may execute a function corresponding to the recognized voice, i.e., corresponding to the recognized user intention included in the voice.

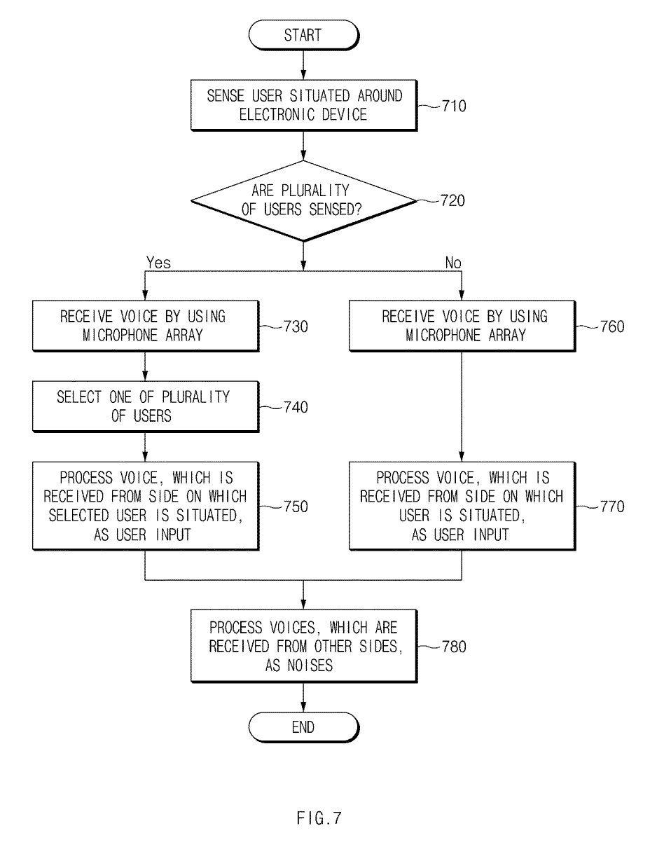

FIG. 7 illustrates a voice processing method of an electronic device, according to an embodiment of the present disclosure. For example, the method of FIG. 7 may be performed by the electronic device illustrated in FIG. 1.

Referring to FIG. 7, in step 710, the electronic device senses a user located near the electronic device, e.g., by using a sensor module. The electronic device may determine to whether the user is located near the electronic device and a direction in which the user is located.

In step 720, the electronic device determines whether a plurality of users are sensed.

If a plurality of users are sensed in step 720, the electronic device receive a voice by using a microphone array in step 730. The microphone array may include a plurality of microphones that are arranged to face specified directions, which may be different directions from each other.

In step 740, the electronic device selects one of the plurality of users. For example, the electronic device may select a user that first utters a specified command, among from the plurality of users, or may select a user having a highest priority among the plurality of users.

In step 750, the electronic device processes a voice received from a direction in which the selected user is located, from among voices received through the plurality of microphones, as a user input.

However, if only one user is sensed in step 720, the electronic device receives a voice by using the microphone array in step 760.

In step 770, the electronic device processes the voice received from a direction in which the user is located, as the user input.

In step 780, the electronic device process voices received from other directions, as noise. For example, the electronic device may perform noise canceling on the voice received from the direction in which the selected user is located, by using voices received from the other directions.

Thereafter, the electronic device may perform voice recognition by using the voice signal on which the noise canceling is performed. The electronic device may change the voice signal into text, and then recognize a user intention by analyzing the text. The electronic device may search for or generate feedback information corresponding to the recognized user intention included in the voice. As described above, the feedback information may include text, audio, an image, etc.

The electronic device may provide feedback associated with the recognized voice. For example, the electronic device may display the feedback information in a display, or may output the feedback information through a speaker. If the feedback information in text form is received, the electronic device may change the text into voice by using a TTS algorithm and may output the feedback information in voice form through the speaker.

The electronic device may execute a function corresponding to the recognized voice, i.e., may execute a function corresponding to the user's intention included in the voice.

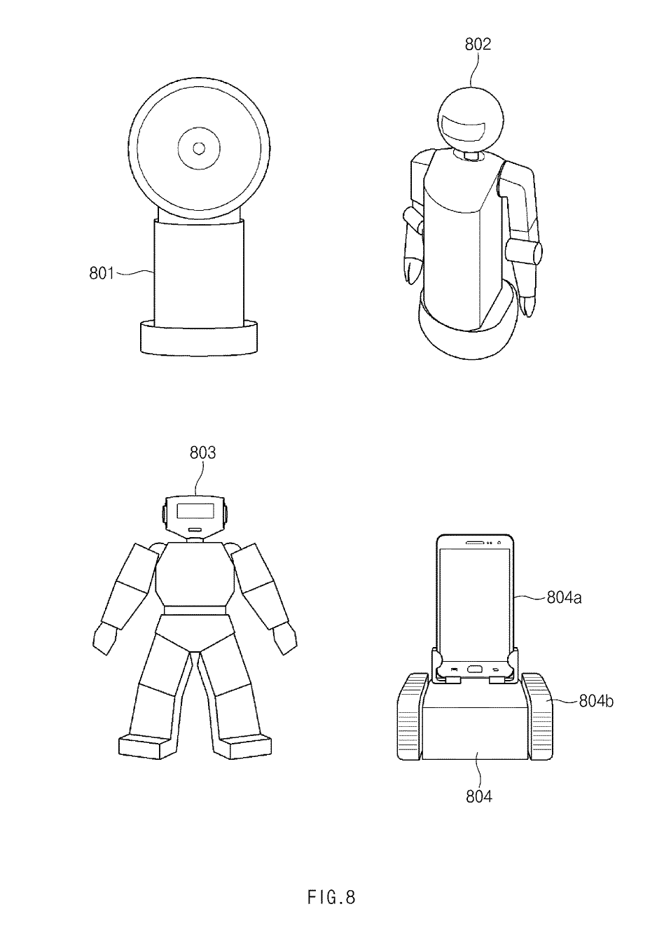

FIG. 8 illustrates examples of an electronic device, according to an embodiment of the present disclosure.

Referring to FIG. 8, examples of an electronic device include standalone-type electronic devices 801, 802, and 803 and a docking-station-type electronic device 804. Each of the standalone-type electronic devices 801, 802, and 803 may independently perform all functions of the electronic device illustrated in FIG. 1.

In the docking-station-type electronic device 804, two or more electronic devices operatively separated may be combined into one electronic device. The docking-station-type electronic device 804 may perform all functions of the electronic device illustrated in FIG. 1. For example, the docking-station-type electronic device 804 may include a body 804a (e.g., a head mount display (HMD) device) and a drive unit 804b, and the body 804a mounted in a docking station (the drive unit 804b) may move to a desired location.

The electronic devices may also be classified as a fixed-type electronic device 801 and movement-type electronic devices 802, 803, and 804 based on their ability to move. The fixed-type electronic device 801 fails to autonomously move because the fixed-type electronic device 801 does not have the drive unit. Each of the movement-type electronic devices 802, 803, and 804 may include a drive unit and may move to a desired location. Each of the movement-type electronic devices 802, 803, and 804 may include a wheel, a caterpillar, and/or legs as the drive unit. Further, each of the movement-type electronic devices 802, 803, and 804 may include a drone.

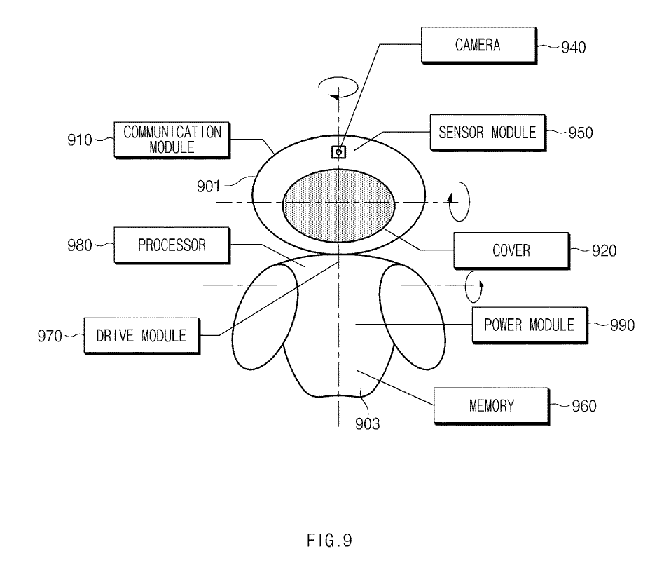

FIG. 9 illustrates an electronic device, according to an embodiment of the present disclosure.

Referring to FIG. 9, an electronic device is provided in the form of a robot including a first body part 901 (e.g., a head) and a second body part 903 (e.g., a torso). The electronic device includes a cover 920 that is arranged on a front surface of the first body 901. The cover 920 may be formed of transparent material or translucent material. The cover 920 may indicate a direction for interacting with a user. The cover 920 may include at least one sensor that senses an image, at least one microphone that obtains audio, at least one speaker that outputs the audio, a display, and/or a mechanical eye structure. The cover 920 may display a direction through light or a temporary device change. When the electronic device interacts with a user, the cover 920 may include at least one or more hardware (H/W) or mechanic structures that face a direction of the user.

The first body part 901 includes a communication module 910 and a sensor module 950. The communication module 910 may receive a message from an external electronic device and may send a message to the external electronic device.

The camera 940 may photograph an external environment of the electronic device. For example, the camera 940 may generate an image by photographing the user.

The sensor module 950 may obtain information about the external environment. For example, the sensor module 950 may sense a user approaching the electronic device. The sensor module 950 may sense proximity of the user based on proximity information or may sense the proximity of the user based on a signal from another electronic device (e.g., a wearable device) that the user wears. In addition, the sensor module 950 may sense an action and a location of the user.

A drive module 970 may include at least one motor for moving the first body 901. The drive module 970 may also change a direction of the first body 901. As the direction of the first body 901 is changed, a photographing direction of the camera 940 may be to changed. The drive module 970 may be capable of moving vertically or horizontally about at least one or more axes, and may be implemented in various manners.

A power module 990 may supply power to the electronic device.

A processor 980 may obtain a message, which is wirelessly received from another electronic device, through the communication module 910 and may obtain a voice message through the sensor module 950. The processor 980 may include at least one message analysis module. The at least one message analysis module may extract main content, which a sender wants to send to a receiver, from a message that the sender generates or may classify the content.

The memory 960 may be a storage unit, which is capable of permanently or temporarily storing information associated with providing the user with a service, and may be included in the electronic device. The information in the memory 960 may be in a cloud or another server through a network. The memory 960 may store spatial information, which is generated by the electronic device or which is received from the outside.

In the memory 960, personal information for user authentication, information about attributes associated with a method for providing the user with the service, and information for recognizing a relation between various options for interacting with the electronic device may be stored. The information about the relation may be changed because the information is updated or learned according to usage of the electronic device.

The processor 980 may control the electronic device. The processor 980 may operatively control the communication module 910, the display, the speaker, the microphone, the camera 940, the sensor module 950, the memory 960, the drive module 970, and the power module 990 to provide the user with the service.

An information determination unit that determines information, which the electronic device is capable of obtaining, may be included in at least a part of the processor 980 or the memory 960. The information determination unit may extract one or more pieces of data for the service from information obtained through the sensor module 950 or the communication module 910.

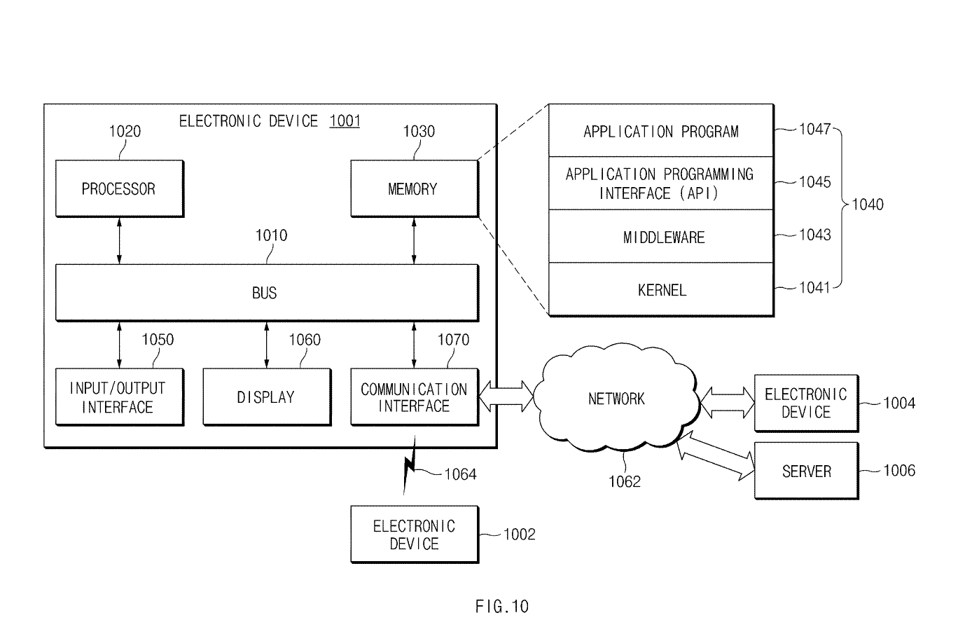

FIG. 10 illustrates an electronic device in a network environment, according to an embodiment of the present disclosure.

Referring to FIG. 10, an electronic device 1001 in a network environment includes a bus 1010, a processor 1020, a memory 1030, an input/output interface 1050, a display 1060, and a communication interface 1070. Alternatively, at least one of the foregoing elements may be omitted or another element may be added to the electronic device 1001.

The bus 1010 may include a circuit for connecting the above-mentioned elements 1010 to 1070 to each other and transferring communications (e.g., control messages and/or data) among the above-mentioned elements.

The processor 1020 may include at least one of a CPU, an AP, or a communication processor (CP). The processor 1020 may perform data processing or an operation related to communication and/or control of at least one of the other elements of the electronic device 1001.

The memory 1030 may include a volatile memory and/or a nonvolatile memory. The memory 1030 may store instructions or data related to at least one of the other elements of the electronic device 1001. The memory 1030 stores software and/or a program 1040. The program 1040 includes a kernel 1041, a middleware 1043, an application programming interface (API) 1045, and an application program (or an application) 1047. At least a portion of the kernel 1041, the middleware 1043, and/or the API 1045 may be referred to as an operating system (OS).

The kernel 1041 may control or manage system resources (e.g., the bus 1010, the processor 1020, the memory 1030, etc.) used to perform operations or functions of other programs (e.g., the middleware 1043, the API 1045, or the application program 1047). Further, the kernel 1041 may provide an interface for the middleware 1043, the API 1045, and/or the application program 1047 to access individual elements of the electronic device 1001.

The middleware 1043 may serve as an intermediary for the API 1045 and/or the application program 1047 to communicate and exchange data with the kernel 1041.

Further, the middleware 1043 may handle one or more task requests received from the application program 1047 according to a priority order. For example, the middleware 1043 may assign at least one application program 1047 a priority for using the system resources of the electronic device 1001. For example, the middleware 1043 may handle the one or more task requests according to the priority assigned to the at least one application, thereby performing scheduling or load balancing with respect to the one or more task requests.

The API 1045, which allows the application 1047 to control a function provided by the kernel 1041 or the middleware 1043, may include at least one interface or function (e.g., instructions) for file control, window control, image processing, character control, etc.

The input/output interface 1050 may transfer an instruction or data input from a user or another external device to (an)other element(s) of the electronic device 1001. Further, the input/output interface 1050 may output instructions or data received from (an)other element(s) of the electronic device 1001 to the user or another external device.

The display 1060 may include a liquid crystal display (LCD), a light-emitting diode (LED) display, an organic light-emitting diode (OLED) display, a microelectromechanical systems (MEMS) display, and/or an electronic paper display. The display 1060 may present various content (e.g., text, an image, a video, an icon, a symbol, etc.) to the user. The display 1060 may include a touch screen, and may receive a touch, gesture, proximity, and/or hovering input from an electronic pen or a part of a body of the user.

The communication interface 1070 may set communications between the electronic device 1001 and a first external electronic device 1002, a second external electronic device 1004, and/or a server 1006. For example, the communication interface 1070 may be connected to a network 1062 via wireless communications or wired communications so as to communicate with the second external electronic device 1004 or the server 1006.

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include a short-range communications 1064, such as wireless fidelity (Wi-Fi), Bluetooth, Bluetooth low energy (BLE), Zigbee, near field communication (NFC), magnetic secure transmission (MST), GNSS, etc. The GNSS may include at least one of global positioning system (GPS), global navigation satellite system (GLONASS), BeiDou navigation satellite system (BeiDou), or Galileo, the European global satellite-based navigation system, according to a use area or a bandwidth. Hereinafter, the term “GPS” and the term “GNSS” may be interchangeably used.

The wired communications may include at least one of universal serial bus (USB), high definition multimedia interface (HDMI), recommended standard 232 (RS-232), plain old telephone service (POTS), etc. The network 1062 may include at least one of telecommunications networks, such as a computer network (e.g., local area network (LAN) or wide area network (WAN)), the Internet, or a telephone network.

The types of the first external electronic device 1002 and the second external electronic device 1004 may be the same as or different from the type of the electronic device 1001. The server 1006 may include a group of one or more servers. A portion or all of operations performed in the electronic device 1001 may be performed in one or more of the first electronic device 1002, the second external electronic device 1004, and the server 1006.

When the electronic device 1001 should perform a certain function or service automatically or in response to a request, the electronic device 1001 may request at least a portion of functions related to the function or service from the first electronic device 1002, the second external electronic device 1004, and/or the server 1006, instead of or in addition to performing the function or service for itself. The first electronic device 1002, the second external electronic device 1004, and/or the server 1006 may perform the requested function or additional function, and may transfer a result of the performance to the electronic device 1001. The electronic device 1001 may use a received result itself or additionally process the received result to provide the requested function or service. To this end, a cloud computing technology, a distributed computing technology, or a client-server computing technology may be used.

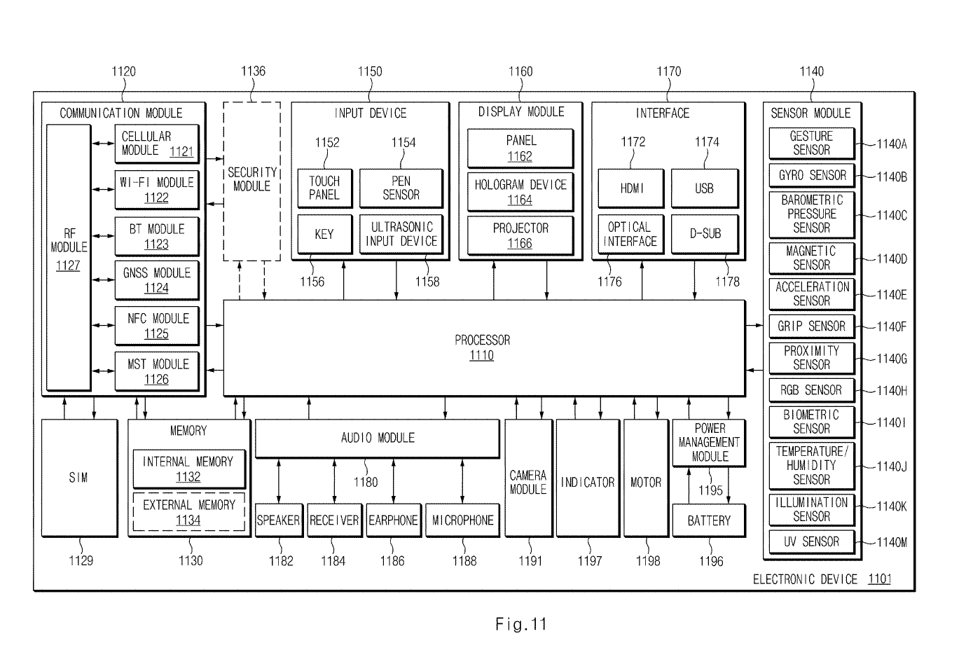

FIG. 11 illustrates an electronic device, according to an embodiment of the present disclosure.

Referring to FIG. 11, an electronic device 1101 includes a processor (e.g., AP) 1110, a communication module 1120, a subscriber identification module (SIM) 1129, a memory 1130, a sensor module 1140, an input device 1150, a display module 1160, an interface 1170, an audio module 1180, a camera module 1191, a power management module 1195, a battery 1196, an indicator 1197, and a motor 1198.

The processor 1110 may run an OS or an application program in order to control a plurality of hardware or software elements connected to the processor 1110, and may process various data and perform operations. The processor 1110 may be implemented with a system on chip (SoC). The processor 1110 may also include a GPU and/or an image signal processor (ISP). The processor 1110 may include at least a portion of the elements illustrated in FIG. 11 (e.g., a cellular module 1121).

The processor 1110 may load, on a volatile memory, an instruction or data received from at least one of other elements (e.g., a nonvolatile memory) to process the instruction or data, and may store various data in a nonvolatile memory.

The communication module 1120 includes the cellular module 1121, a Wi-Fi module 1122, a Bluetooth module 1123, a GNSS module 1124 (e.g., a GPS module, a GLONASS module, a BeiDou module, and/or a Galileo module), an NFC module 1125, a magnetic secure transmission (MST) module 1126, and an RF module 1127.

The cellular module 1121 may provide, for example, a voice call service, a video call service, a text message service, or an Internet service through a communication network. The cellular module 1121 may identify and authenticate the electronic device 1101 in the communication network using the subscriber identification module 1129 (e.g., a SIM card). The cellular module 1121 may perform at least a part of functions that may be provided by the processor 1110. The cellular module 1121 may include a CP.

Each of the Wi-Fi module 1122, the Bluetooth module 1123, the GNSS module 1124, the NFC module 1125, and the MST module 1126 may include a processor for processing data transmitted/received through the modules. At least two of the cellular module 1121, the Wi-Fi module 1122, the Bluetooth module 1123, the GNSS module 1124, the NFC module 1125, and the MST module 1126 may be included in a single integrated chip (IC) or IC package.

The RF module 1127 may transmit/receive communication signals (e.g., RF signals). The RF module 1127 may include a transceiver, a power amp module (PAM), a frequency filter, a low noise amplifier (LNA), an antenna, etc. At least one of the cellular module 1121, the Wi-Fi module 1122, the Bluetooth module 1123, the GNSS module 1124, the NFC module 1125, and the MST module 1126 may transmit/receive RF signals through a separate RF module.

The SIM 1129 may include an embedded SIM and/or a card containing the SIM, and may include unique identification information (e.g., an integrated circuit card identifier (ICCID)) or subscriber information (e.g., international mobile subscriber identity (IMSI)).

The memory 1130 includes an internal memory 1132 and an external memory 1134. The internal memory 1132 may include at least one of a volatile memory (e.g., a dynamic RAM (DRAM), a static RAM (SRAM), a synchronous dynamic RAM (SDRAM), etc.), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, etc.)), a hard drive, or a solid state drive (SSD).

The external memory 1134 may include a flash drive such as a compact flash (CF), a secure digital (SD), a Micro-SD, a Mini-SD, an extreme digital (xD), a MultiMediaCard (MMC), a memory stick, etc. The external memory 1134 may be operatively and/or physically connected to the electronic device 1101 through various interfaces.

A security module 1136, which includes a storage space that is higher in security level than the memory 1130, secures safe data storage and protected execution circumstances. The security module 1136 may be implemented with an additional circuit and may include an additional processor. The security module 1136 may be present in an attachable smart chip or SD card, or may include an embedded secure element (eSE), which is installed in a fixed chip. Additionally, the security module 1136 may be driven in another OS which is different from the OS of the electronic device 1101. For example, the security module 1136 may operate based on a Java card open platform (JCOP) OS.

The sensor module 1140 may measure physical quantity or detect an operation state of the electronic device 1101 and convert measured or detected information into an electrical signal. The sensor module 1140 includes a gesture sensor 1140A, a gyro sensor 1140B, a barometric pressure sensor 1140C, a magnetic sensor 1140D, an acceleration sensor 1140E, a grip sensor 1140F, a proximity sensor 1140G, a color (e.g., a red/green/blue (RGB)) sensor 1140H, a biometric sensor 1140I, a temperature/humidity sensor 1140J, an illumination sensor 1140K, and an ultraviolet (UV) sensor 1140M. Additionally or alternatively, the sensor module 1140 may include an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 1140 may further include a control circuit for controlling at least one sensor included therein. In some various embodiments of the present disclosure, the electronic device 1101 may further include a processor configured to control the sensor module 1140 as a part of the processor 1110 or separately, so that the sensor module 1140 is controlled while the processor 1110 is in a sleep state.

The input device 1150 includes a touch panel 1152, a (digital) pen sensor 1154, a key 1156, and an ultrasonic input device 1158. The touch panel 1152 may employ at least one of capacitive, resistive, infrared, and ultraviolet sensing methods. The touch panel 1152 may further include a control circuit. The touch panel 1152 may further include a tactile layer in order to provide a haptic feedback to a user.

The (digital) pen sensor 1154 may include a sheet for recognition which is a part of a touch panel or is separate.

The key 1156 may include a physical button, an optical button, and/or a keypad.

The ultrasonic input device 1158 may sense ultrasonic waves generated by an input tool through a microphone 1188 in order to identify data corresponding to the ultrasonic waves sensed.

The display 1160 includes a panel 1162, a hologram device 1164, and a projector 1166. The panel 1162 may be flexible, transparent, and/or wearable. The panel 1162 and the touch panel 1152 may be integrated into a single module.

The hologram device 1164 may display a stereoscopic image in a space using a light interference phenomenon.

The projector 1166 may project light onto a screen in order to display an image. The screen may be disposed in the inside or the outside of the electronic device 1101.

The display 1160 may further include a control circuit for controlling the panel 1162, the hologram device 1164, and/or the projector 1166.

The interface 1170 includes an HDMI 1172, a USB 1174, an optical interface 1176, and a D-subminiature (D-sub) 1178. Additionally or alternatively, the interface 1170 may include a mobile high-definition link (MHL) interface, an SD card/multi-media card (MMC) interface, and/or an infrared data association (IrDA) interface.

The audio module 1180 may convert a sound into an electrical signal or vice versa. The audio module 1180 may process sound information input or output through a speaker 1182, a receiver 1184, an earphone 1186, and/or the microphone 1188.

The camera module 1191 shoots still or video images. The camera module 1191 may include at least one image sensor (e.g., a front sensor or a rear sensor), a lens, an ISP, or a flash (e.g., an LED or a xenon lamp).

The power management module 1195 may manage power of the electronic device 1101. The power management module 1195 may include a power management integrated circuit (PMIC), a charger integrated circuit (IC), and/or a battery gauge. The PMIC may employ a wired and/or wireless charging method. The wireless charging method may include a magnetic resonance method, a magnetic induction method, an electromagnetic method, etc. An additional circuit for wireless charging, such as a coil loop, a resonant circuit, a rectifier, etc., may be further included.

The battery gauge may measure a remaining capacity of the battery 1196 and a voltage, current, or temperature thereof.

The battery 1196 may include a rechargeable battery and/or a solar battery.

The indicator 1197 may display a specific state of the electronic device 1101 or a part thereof (e.g., the processor 1110), such as a booting state, a message state, a charging state, etc.

The motor 1198 may convert an electrical signal into a mechanical vibration, and may generate a vibration or haptic effect.

Although not illustrated, a processing device (e.g., a GPU) for supporting a mobile TV may be included in the electronic device 1101. The processing device for supporting a mobile TV may process media data according to the standards of digital multimedia broadcasting (DMB), digital video broadcasting (DVB), MediaFLO™, etc.

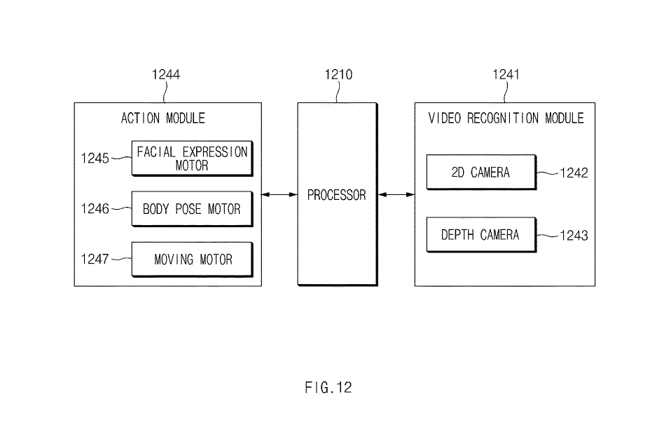

FIG. 12 illustrates an electronic device, according to an embodiment of the present disclosure.

Referring to FIG. 12, the electron device includes a processor 1210 connected with a video recognition module 1241 and an action module 1244. The video recognition module 1241 includes a 2D camera 1242 and a depth camera 1243. The video recognition module 1241 may perform recognition based on a photographed result and may send the recognition result to the processor 1210.

The action module 1244 includes a facial expression motor 1245 that indicates a facial expression in the electronic device or changes a direction of a face of the electronic device, a body pose motor 1245 that changes a pose of a body unit in the electronic device, e.g., locations of arms, legs, or fingers, and a moving motor 1247 that moves the electronic device. The processor 1210 may control the facial expression motor 1245, the body pose motor 1246, and the moving motor 1247 to control motion of the electronic device, e.g., implemented as a robot. The processor 1210 may control a facial expression, a head, or a body of the electronic device, which is implemented as a robot, based on motion data received from an external electronic device. For example, the electronic device may receive the motion data, which is generated based on a facial expression, head motion, or body motion of the user of the external electronic device, from the external electronic device. The processor 1210 may extract each of facial expression data, head motion data, or body motion data included in the motion data, and may control the facial expression motor 1245 or the body pose motor 1246 based on the extracted data.

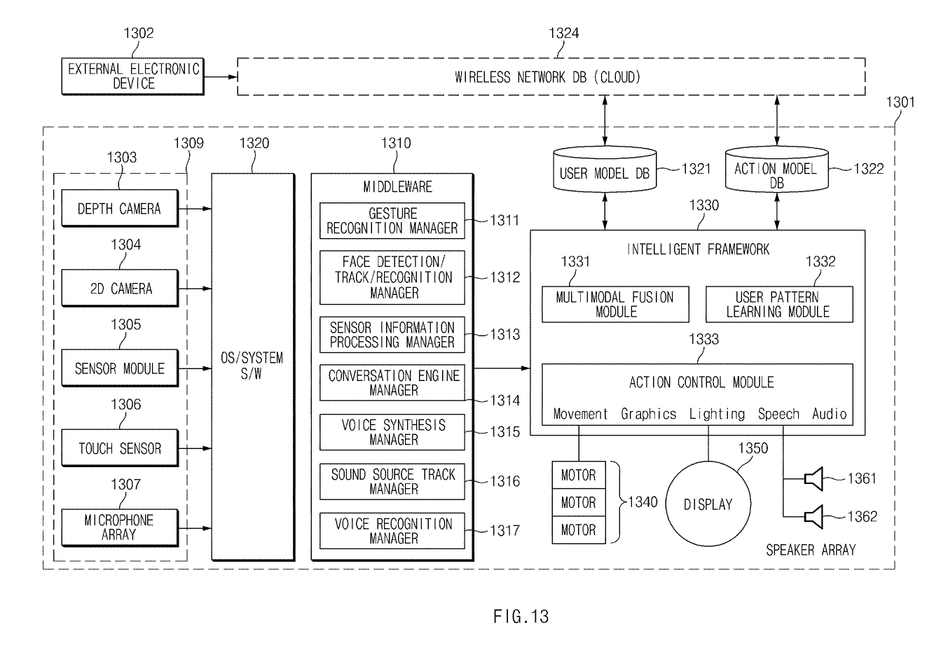

FIG. 13 illustrates a software block diagram of an electronic device, according to an embodiment of the present disclosure.

Referring to FIG. 13, an electronic device 1301 includes middleware 1310, an OS/system software 1320, and an intelligent framework 1330.

The OS/system software 1320 may distribute a resource of the electronic device 1301 and may perform job scheduling and may operate a process. In addition, the OS/system software 1320 may process data received from hardware input units 1309. The hardware input units 1309 includes a depth camera 1303, a two-dimensional (2D) camera 1304, a sensor module 1305, a touch sensor 1306, and a microphone array 1307.

The middleware 1310 may perform a function of the electronic device 1301 by using data that the OS/system software 1301 processes. The middleware 1310 includes a gesture recognition manager 1311, a face detection/track/recognition manager 1312, a sensor information processing manager 1313, a conversation engine manager 1314, a voice synthesis manager 1315, a sound source track manager 1316, and a voice recognition manager 1317.

The gesture recognition manager 1311 may recognize a three-dimensional (3D) gesture of the user by analyzing an image that is photographed by using the 2D camera 1304 and the depth camera 1303.

The face detection/track/recognition manager 1312 may detect or track a location of the face of a user by analyzing an image that the 2D camera 1304 photographs and may perform authentication through face recognition.

The sound source track manager 1316 may analyze a voice input through the microphone array 1307 and may track an input location associated with a sound source based on the analyzed result.

The voice recognition manager 1317 may recognize an input voice by analyzing a voice input through the microphone array 1307.

The intelligent framework 1330 includes a multimodal fusion module 1331, a user pattern learning module 1332, and an action control module 1333. The multimodal fusion module 1331 may collect and manage information that the middleware 1310 processes. The user pattern learning module 1332 may extract and learn meaningful information, such as a life pattern, preference, etc., of the user by using the information of the multimodal fusion module 1331. The action control module 1333 may provide information, which the electronic device 1301 will feed back to the user, as motion information of the electronic device 1301, visual information, or audio information. That is, the action control module 1333 may control motors 1340 of a drive unit to move the electronic device 1301, may control a display such that a graphic object is displayed in a display 1350, and may control speakers 1361 and 1362 to output audio.

A user model database 1321 may classify data that the electronic device 1301 learns in the intelligent framework 1330 based on a user and may store the classified data. An action model database 1322 may store data for action control of the electronic device 1301.

The user model database 1321 and the action model database 1322 may be stored in a memory of the electronic device 1301 or may be stored in a cloud server through a network 1324, and may be shared with an external electronic device 1302.

Herein, the term “module” may represent a unit including one of hardware, software and firmware or a combination thereof. The term “module” may be interchangeably used with “unit”, “logic”, “logical block”, “component”, or “circuit”. The “module” may be a minimum unit of an integrated component or may be a part thereof. A “module” may be a minimum unit for performing one or more functions or a part thereof. A “module” may be implemented mechanically or electronically. For example, a “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. When the instructions are performed by a processor (e.g., the processor 170), the processor may perform functions corresponding to the instructions. The computer-readable storage medium may be, for example, the memory 160.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, etc.). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Further, some operations may be performed in another order or may be omitted, or other operations may be added.

According to various embodiments of the present invention, an electronic device may prevent improper voice controlled operations by accurately distinguishing a voice command of a user from a voice output from another device and may improve voice recognition performance by removing noise included in a user voice.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device, comprising:
a microphone array including a plurality of microphones facing specified directions;
a sensor module configured to sense a user located near the electronic device; and
a processor configured to:
select one of a plurality of users sensed near the electronic device,
process a voice received from a direction in which the selected user is located, as a user input, and
process a voice received from another direction, as noise.

2. The electronic device of claim 1, wherein the processor is further configured to select a user that first speaks a specified command, from among the plurality of users.

3. The electronic device of claim 1, wherein the processor is further configured to:
distinguish the plurality of users by using respective voices received from the plurality of users;
determine respective priorities of the distinguished plurality of users; and
select a user having a highest priority from among the distinguished plurality of users.

4. The electronic device of claim 3, wherein the processor is further configured to select a user having a next highest priority, if the user having the highest priority stops speaking.

5. The electronic device of claim 1, wherein the sensor module comprises:
a first sensor configured to sense a body of the user in response to motion of the user; and
a second sensor configured to sense an object located in a specified direction.

6. The electronic device of claim 5, wherein the processor is further configured to:
activate the first sensor; and
deactivate the first sensor and activate the second sensor, if the body of the user is to sensed by the first sensor.

7. The electronic device of claim 6, wherein the processor is further configured to deactivate the second sensor and re-activate the first sensor, if the object is not sensed by the second sensor.

8. The electronic device of claim 1, wherein the processor is further configured to perform noise canceling on the voice received from the direction in which the selected user is located, by using the voice received from the another direction.

9. The electronic device of claim 1, further comprising:
a display; and
a speaker,
wherein the processor is further configured to:
recognize the voice received from the direction in which the selected user is located; and
provide feedback associated with the voice by using at least one of the display and the speaker.

10. The electronic device of claim 1, wherein the processor is further configured to:
recognize the voice received from the direction in which the selected user is located; and
execute a function corresponding to the recognized voice.

11. A voice processing method of an electronic device, the method comprising:
sensing a plurality of users located near the electronic device;
receiving voices via a microphone array including a plurality of microphones facing to specified directions;
selecting one of the plurality of users;
processing a voice received from a direction in which the selected user is located, as a user input; and
processing a voice received from another direction, as noise.

12. The method of claim 11, wherein selecting one of the plurality of users comprises selecting a user that first speaks a specified command, from among the plurality of users.

13. The method of claim 11, wherein selecting one of the plurality of users comprises:
distinguishing the plurality of users by using the voices received from the plurality of users;
determining respective priorities of the distinguished plurality of users; and
selecting a user having a highest priority, from among the distinguished plurality of users.

14. The method of claim 13, wherein selecting one of the plurality of users further comprises selecting a user having a next highest priority if the user having the highest priority stops speaking.

15. The method of claim 11, wherein sensing the users located near the electronic device comprises:
activating a first sensor configured to sense a body of the user in response to motion of a user; and
deactivating the first sensor and activating a second sensor configured to sense an object, which is located on a specified direction, if the body of the user is sensed by the first sensor.

16. The method of claim 15, wherein sensing the users located around the electronic device further comprises deactivating the second sensor and re-activating the is first sensor, if an object is not sensed by the second sensor.

17. The method of claim 11, further comprising performing noise canceling on the voice received from the direction in which the selected user is located, by using the voice received from the another direction.

18. The method of claim 11, further comprising:
recognizing the voice received from the direction in which the selected user is located; and
providing feedback associated with the recognized voice by using at least one of a display and a speaker.

19. The method of claim 11, further comprising:
recognizing the voice received from the direction in which the selected user is located; and
executing a function corresponding to the recognized voice.

20. A non-transitory computer-readable recording medium recording a program, which when executed, causes a computer to:
sense a plurality of users located near the electronic device;
receive voices via a microphone array including a plurality of microphones facing specified directions;
select one of the plurality of users;
processing a voice received from a direction in which the selected user is located, as a user input; and
processing a voice received from another direction, as noise.
